(19) United States
(12) Patent Application Publication
(10) Pub. No.: US 2026/0278122 A1
(43) Pub. Date: Sep. 17, 2026

(54) DEVICE WITH FLEXIBLE COMMUNICATIONS STRUCTURE FOR REAL-TIME CAPABLE NETWORK APPLICATIONS WITH HIGH DATA SECURITY, IN PARTICULAR AUTOMATION DEVICE, AND METHOD FOR CONFIGURATION THEREOF

(71) Applicants: Sebastian HILSCHER, Hattersheim (DE); Hilscher Gesellschaft für Systemautomation mbH, Hattersheim (DE)

(72) Inventors: Sven FIEDRICH, Berlin (DE); Nico MÄDING, Flörsheim (DE)

(21) Appl. No.: 19/472,329

(22) PCT Filed: Mar. 27, 2024
(86) PCT No.: PCT/EP2024/025137

§ 371 Date: Oct. 3, 2025

(30) Foreign Application Priority Data
Apr. 6, 2023 (DE) 10 2023 001 381.1

(51) Int. Cl. G06F 21/60; G06F 21/85; H04L 12/40; H04L 67/12

(52) U.S. Cl. CPC G06F 21/602; G06F 21/606; G06F 21/85; H04L 67/12; H04L 2012/40221

(57) ABSTRACT

The invention relates to a device with a flexible communications structure for real-time capable network applications with high data security, in particular an automation device, and a method for configuration thereof. To support all the market-relevant communications protocols used in automation engineering and enabling single-cycle access at best and kept latency low, the device (AG) has at least one flexible data processing structure integrated in a data controller (DC) and having a cryptography accelerator (KB) and an exchangeable physical interface (PYS) arranged in the device (AG) and connected to communications controller (KC) arranged in a communications processor (KP) via signal lines for transmitting an identification code (ID), control data (ST), receive data (ED) and transmit data (SD) in such a way that processing, filtering and distribution of data streams is implemented with transmission rates in the range from 10 Mbps to 1 Gbps.

The invention relates, according to claim 1, to a device and, according to claim 7, to a method for configuring the device.

In control and automation technology, it is known to use fieldbuses and Ethernet, especially the extension to Real-Time Ethernet, for data communication between individual units involved in the control of a process. Examples of classic fieldbuses are CANopen, PROFIBUS, Modbus, DeviceNet or CC-Link. Examples of well-known real-time Ethernet systems include PROFINET, EtherNet/IP, EtherCAT, Sercos, POWERLINK, and CC-Link IE. Examples of future gigabit-capable real-time Ethernet systems include PROFINET over TSN, EtherCAT-G, and OPC UA over TSN. Communication between the units takes place on the fieldbus/Ethernet using specified protocols. In order to meet the demand for open networking systems, there is a need to provide simple and cost-effective communication mechanisms to make industrial devices network-capable. This requirement is particularly relevant in connection with the coupling of drive components, such as between drive controls, power units and encoders in numerically controlled machine tools and robots, where a number of interpolating axes must be operated synchronously. As a result of the increasing networking of various technical systems, the demand for standardized structures in industry is growing.

In distributed automation systems, for example in the field of drive technology, certain data must arrive at the designated participants at specific times (i.e. real-time critical data) and be processed by the recipients. According to IEC 61491, EN61491 SERCOS interface-Technical brief, successful real-time critical data traffic of the type mentioned can be ensured in distributed automation systems. Furthermore, synchronous, clocked communication systems with equidistance properties are known from automation technology, as described, for example, in DE 101 40 861 A1 for a system and a method for transmitting data between data networks is described.

In order to design a method and a device for data communication and configuration of bus participants of an open automation system in such a way that the connection of any bus participants with individual, interactive communication and the interchangeability of parts of the device is possible, from EP1894113B1 the applicant discloses a method for data communication, for coupling bus subscribers of an open automation system with distributed control, communicating with one another via a serial data bus, which interact via at least two communication controllers with a higher-level control device, in which:
each communication controller comprises at least three freely programmable communication ALU, namely the first communication ALU, the second communication ALU and the third communication ALU,
a plurality of commands are coded for each communication controller of a command code of the first and second communication ALU of the communication ALUs, wherein the method is characterized in that
   for each communication controller:
logic function blocks are arranged parallel to one another in the first and second communication ALU and simultaneously process the command code, which carry out the communication functions,
the first communication ALU carries out the reception and decoding of a bit or nibble-oriented serial data stream and the serial/parallel conversion thereof in byte, word or double word representation,
the second communication ALU carries out the conversion of byte, word or double-word representation into bits or nibble-oriented serial data and the coding and transmission carries out this serial data stream and the third communication ALU has a monitoring logic, which simultaneously monitors a multiplicity of events and which, in the event of an event, starts within a system clock with the associated program code, wherein a plurality of commands are executed in one system clock and
the third communication ALU controls the transmission and reception profile of an associated data packet,
   whereby the communication functions are not permanently predefined but are formed by means of the freely programmable communication ALUs, wherein each communication controller is suitably configured by reading in an identification code in the start phase and later each associated communication ALU is suitably configured, and whereby transitions between networks are realized by means of the higher-level control device and each communication controller.

For each communication controller, the higher-level control device together with the communication ALU(s) are integrated in a circuit which contains a dual-port memory for coupling to an external control device (host system), or the higher-level control device of the circuit executes the entire application, which then leads out the internal system bus as an extension bus for connecting external memory and peripheral components, and where the same signals are used for both operating modes and these are switched via software.

Furthermore, from EP1894113B1 the applicant discloses a device for data communication, for coupling bus subscribers of an open automation system with distributed control, said bus subscribers communicating with each other via a serial data bus, having:
at least two communication controllers, which interact with a higher-level control device and which comprise at least three freely programmable communication ALUs, namely the first communication ALU, the second communication ALU and the third communication ALU,
a command code in which a plurality of commands are encoded, wherein the device is characterized by the following features:
a parallel arrangement of at least two logic function blocks, which simultaneously process the command code into the first and
second communication ALU, which carries out the communication functions,
the first communication ALU carries out the reception and decoding of a bit or nibble-oriented serial data stream and its serial/parallel conversion into byte, word or double word representation,
the second communication ALU carries out the conversion of byte, word or double word representation into bits or nibble-oriented serial data and the coding and transmission carries out this serial data stream and
the third communication ALU has a monitoring logic, which simultaneously monitors a plurality of events and which, in the event of an event, starts within a system clock with the associated program code, wherein a plurality of commands are executed in a system clock, and the third communication ALU controls the transmission and reception profile of an associated data packet,
   whereby the communication functions are not permanently predefined but are formed by means of the freely programmable communication ALUs, wherein each communication controller is suitably configured by reading in an identification code in the start phase and later each associated communication ALU is suitably configured, and whereby transitions between networks are realized by means of the higher-level control device and two communication controllers.

In comparison to the construction of a dedicated communication controller by programming FPGAs (Field Programmable Gate Array) or parts thereof according to the prior art, which also correspond to hard-wired logic, the subject matter of EP1894113B1 of the applicant enables the construction of a “quasi-dedicated” communication controller in a simple manner by constructing it as one or more freely programmable communication ALUs (Arithmetic and Logical Units) which have an instruction set and hardware architecture optimized for the communication tasks. This solution offers the following advantages:
The development, production and distribution of such a circuit can be carried out independently of a specific fieldbus system/Ethernet.
Extensions within the fieldbus/Ethernet and real-time Ethernet specifications or implementations of completely new fieldbus systems can be carried out via software updates and do not require a new circuit.
Especially with two or more communication interfaces within a circuit the respective fieldbus/Ethernet systems are defined by loading the software and can therefore be combined completely flexibly.
Furthermore, in the subject matter of EP1894113B1 of the applicant, in contrast to conventional ALUs, the instructions are executed in parallel in one cycle. For this purpose, the corresponding logic function blocks in the ALUs are arranged in parallel and can process the instruction code simultaneously, which means that even at high baud rates, e.g. 100/1000 Mbps Ethernet, the necessary functions can be realized. For each communication controller, an exchangeable, physical interface without its own intelligence or controller function is provided, which is connected to the communication controller via four signal line groups for transmitting an identification code, control data, receive data and transmit data. This interface registers itself with the freely programmable communication controller using an identification code in the start-up phase, so that the physical interface is exchangeable and extensions within a fieldbus specification or implementations of completely new fieldbus systems can be carried out via software update. Finally, for each communication controller, the physical interface is designed as a printed circuit with a connector of a communication network or with a connector of a communication network as an integrated unit, and the communication processor processes both an application and a transmission protocol.

Furthermore, from EP2110754B1 the applicant discloses a method and a device for synchronizing bus participants of an open automation system. The method for synchronizing bus participants communicating with each other via a serial data bus of an open automation system with distributed control is designed in such a way that an automatic and highly accurate synchronization is made possible by one of the bus participants having at least one communication controller, that one of the at least one communication controller, which is referred to as the communication controller in the following text, has three freely programmable communication ALUs, namely the first communication ALU, the second communication ALU and the third communication ALU, cooperates with a downstream control device and that the method comprises the following steps:
said communication controller detects the occurrence of a specific date or event,
said communication-ALUs autonomously and without said downstream control device performs completely deterministic the synchronous control functions, whereby said first communication-ALU decodes corresponding to the transmission rate of the received bit or nibble serial data stream and converts it into a parallel representation, said second communication-ALU encodes data from a parallel representation into a bit- or nibble-serial data stream and applies it with the correct transmission rate to the line and said third communication-ALU controls the transmission and reception history of a related data packet and
between the synchronization times the measurement and control values are exchanged between said communication controller (KC) and said control device (CPU), whereby said communication controller (KC), said three communication-ALUs (RPA, TPA, PEA) and said control device (CPU) are adapted such, that the interrupt latency period of the downstream control device (CPU) do not affect the synchronization.

Alternatively, a method is known from EP 2110754B1 of the applicants, wherein the method is characterized in that one of the bus participants has at least one communication controller, and that one of the at least one communication controller, which is referred to as the communication controller in the following text, cooperates with a downstream control device via three freely programmable communication ALUs, which are called the first communication ALU, the second communication ALU and the third communication ALU, and that the method comprises the following steps:
said communication-ALUs autonomously and without said downstream control device performs completely deterministic the synchronous control functions, whereby said first communication-ALU decodes corresponding to the transmission rate of the received bit or Nibble serial data stream is and converts it into a parallel representation, said second communication-ALU encodes data from a parallel representation into a bit- or nibble-serial data stream and applies it with the correct transmission rate to the line, said third communication-ALU controls the transmission and reception history of a related data packet,
as the control functions are cyclic and have a cycle time a synchronized local time is stored in a latch at the starting point of said cyclically control functions,
the cycle time is measured by taking the difference with a synchronized local time stored at the last starting point on the basis with respect to a local time of a local clock and a current cycle time is keeping constant and hold in a fixed phase relation to a local time by increasing or decreasing the current cycle time by means of said control device and
said entire cycle was synchronized both in cycle time and phase to the local time whereby said communication controller, said three communication-ALU and said control device are adapted such, that the interrupt latency period of the downstream control device do not affect the synchronization.

In comparison to the first-mentioned method of EP2110754B1 of the applicants, in which a direct synchronization of the control functions takes place without the downstream control device by means of the “quasi-dedicated” communication controller, the synchronization in the method according to the alternative method is carried out in accordance with a stored local time with each start of a control function, which requires a somewhat higher hardware outlay for maintaining a local time.

Furthermore, from EP 2110754B1 of the applicant, a device for automatic and high-precision synchronization is known, which is characterized in that that one of said bus subscribers having a communication processor with at least one communication controller, wherein one communication controller of said communication controller named following communication controller and having a downstream control device, wherein said communication controller having three freely programmable communication-ALUs, namely named the first communication-ALU, the second communication-ALU and the third communication-ALU, wherein said communication-ALUs are adapted to carry out completely deterministic the synchronous control functions without said control device, whereby said first communication-ALU decodes corresponding to the transmission rate of the received bit or nibble serial data stream and converts it into a parallel representation, said second communication-ALU encodes data from a parallel representation into a bit- or nibble-serial data stream and applies it with the correct transmission rate to the line and said third communication-ALU controls the transmission and reception history of a related data packet, wherein the communication controller is adapted to detect the occurrence of a particular date or event, wherein the device having a logic function block of the communication processor with means for measuring and storing times in said communication-ALUs and wherein said communication controller, said three communication-ALU and said control device are adapted such, that the interrupt latency period of the downstream control device do not affect the synchronization.

As the above assessment of the prior art shows, a device for data communication and for coupling bus participants of an open automation system with distributed control, which communicate with each other via a serial data bus, is known from the applicant's EP1894113B1. Furthermore, from EP2110754B1 the applicant discloses a method and a device for automatic and high-precision synchronization, in which the interrupt latency time of the control device do not affect the synchronization.

The continuous advancement of networking in production means that machines are being equipped with more and more sensors. However, the increase in sensors and actuators and the resulting increase in cabling leads to the problem that the maintenance, fault analysis and installation of wired sensors is becoming increasingly complicated. With the introduction of Industry 4.0, the collection of device and sensor data and its transfer to a cloud platform is becoming increasingly important.

In order to be able to transmit cryptographically protected data transmitted in a first network to a less secure second network and to evaluate it there, DE102015200279 A1 discloses a device for carrying out cryptographically protected communication and a method for the non-reactive acquisition of data which is transmitted in a cryptographically protected manner between devices in a first network and which is listened to by the one-way transmission device in a second network. The method comprises the steps of negotiating at least one cryptographic parameter between the communicating devices in the first network for use in a subsequent communication. In the next method step, a transmission structure in at least one of the devices, which at least partially contains the negotiated cryptographic parameters, is generated and transmitted within the first network. In the subsequent process step, the transmission data structure is monitored by a one-way transmission device and transmitted to the second network. In an advantageous embodiment of the method, the transmission data structure is transmitted protected by a configurable cryptographic transmission key. This ensures in particular that the cryptographic parameters can only be read by an authorized person with whom the transmission key has been agreed. The device for carrying out cryptographically protected communication provided in the subject matter of DE102015200279A1 comprises a negotiation unit which is designed to negotiate cryptographic parameters for carrying out cryptographically protected communication with a communication partner. The device further comprises a generation unit which is designed to generate a transmission data structure which at least partially contains the negotiated cryptographic parameters and to transmit this to the first network. Furthermore, the device can have a generating device which generates a configurable cryptographic transmission key and is designed to output the transmission data structure protected by the cryptographic transmission key to the first network. This ensures that only authorized persons can evaluate the transmission data structure and use it to decrypt the data transmitted in the first network. This also allows you to configure who can evaluate which messages. For example, cryptographic parameters for control messages can be encrypted by a first cryptographic transmission key and, for example, cryptographic parameters for the encryption of diagnostic data can be encrypted by a second transmission key. If the first transmission key is only known to the evaluation unit, the first one-way transmission unit can send messages to the controller but cannot decrypt the diagnostic data. Furthermore, a listening unit can be provided which is designed to listen to cryptographic parameters between devices in a first network and a storage unit which is designed to store the cryptographic parameters and transmit them to a second network. The one-way transmission device may comprise a decryption unit configured to decrypt cryptographically protected data transmitted from the first network using the cryptographic parameters. Furthermore, the decryption device can be designed in such a way that only successfully cryptographically verified intercepted data is forwarded to the second network.

In order to provide a better overview of a fieldbus network and its components on the part of a framework application, a framework application for device access software is known from DE102016120972A1. The frame application can be installed on a host, whereby at least one driver can be integrated into the frame application, which is designed for access to an associated fieldbus component of a fieldbus network. The framework application has at least one standard interface for each integrated driver, via which data can be exchanged between the driver and the framework application. In addition to the at least one standard interface, the frame application has one or more proprietary interfaces for at least some of the integrated drivers, via which data can be exchanged between the respective driver and the frame application, wherein information on additional functionalities supported by the driver or an associated fieldbus component can be transmitted from the driver to the frame application via at least one of the proprietary interfaces. In addition to at least one standard interface, one or more proprietary interfaces are provided between the framework application and at least some of the integrated drivers. For example, merging information on additional functionalities on the framework application side is particularly advantageous if the framework application can be connected to a cloud. For example, information on supported additional functionalities can be uploaded to the cloud along with other data so that a complete overview of the system is available from the cloud. For example, additional functionalities can also be activated from the cloud. This means that the time-consuming activation of additional functionalities on-site, i.e. at the location of the field device, can be replaced by activation from the cloud. In order to correctly address the various components of the fieldbus network, the device access software requires information about the properties and parameters of the field devices, gateways, remote I/Os, etc. of the fieldbus network. This information is usually provided by the manufacturers of the various devices in the form of device description files or device drivers. For the device description for acyclic data exchange, the fieldbus protocols Profibus-DP, Profibus-PA, Fieldbus Foundation and HART use device descriptions according to the standards DTM (Device Type Manager), DD (Device Description), EDD (Enhanced Device Description) and FDI Device Packages. In particular, the EDD and DTM standards specify, in addition to device parameters, device functionality and address space allocation, graphic features and graphical user interfaces that are intended to facilitate the parameterization and configuration of the respective field device. To create these graphical interfaces, the EDD standard provides special graphic commands that are processed in the manner of an interpreter language. In the FDT/DTM standard, the DTMs (Device Type Managers) are provided in the form of dynamically loadable libraries (DLLs) or in the form of executable files (executables). A DTM also includes the graphics features mentioned. The various DTMs for the different components of the fieldbus network are integrated into a common FDT frame application, where FDT stands for “Field Device Tool”. This provides a common framework application into which the DTMs for different devices and from different manufacturers are integrated can. The FDT standard is increasingly being supplemented and possibly replaced by the FDI Device Packages standard. In addition to the previously discussed fieldbus protocols Profibus, Fieldbus Foundation and HART, the so-called Industrial Ethernet protocols are gaining in importance, which include the fieldbus protocols EtherNet/IP, ProfiNet and EtherCAT. The EtherNet/IP fieldbus protocol provides a device description file according to the EDS (Electronic Data Sheet) standard to describe both cyclic and acyclic data exchange. The first possible additional functionality that can be activated for a fee is connectivity to the cloud, which is also known as the “Internet of Things”, or IoT for short. This functionality enables data to be uploaded from a DTM to the cloud via the FDT framework application. There the data can be archived and linked to other data. For example, it is possible to upload flow measurement data to the cloud and use it as a basis for reordering and inventory management. The use of IoT connectivity will be enabled by the DTM. Another additional functionality that can be unlocked is the ability to perform device function tests and self-tests.

Furthermore, DE102016215742A1 discloses a gateway and a method for connecting a data source system to an IT system, wherein the gateway has a real-time capable middleware and a non-real-time capable middleware on a common operating system. The non-real-time middleware runs an application for communicating via a network protocol, such as TCP/IP, OPC-UA or http(s), and the non-real-time middleware includes a framework. Real-time capability means that individual calculation steps are completed within defined time periods. In real-time capable environments, it can be guaranteed that a calculation result is available in a timely manner, so that the movements of different units, especially in industrial machines, also run synchronously. The subject matter of DE102016215742A1 relates to data source systems comprising at least one data source, such as a computing unit (e.g. Programmable Logic Controller (PLC), Numerical Control (NC) or CNC (Computerized Numerical Control)) or a sensor, especially existing ones, can be made “Internet-capable” in a particularly simple way. It is a scalable approach to retrofitting existing machines without programming using only web-based configuration. The solution offers modular expandability with additional sensors, logics and providers and automatic provision of the associated web-based interfaces. Existing PLCs of the data source system can be connected to the data source system via the gateway as an additional component. This enables easy subsequent connection without changing an existing data source system. In this case, PLC functionalities do not have to be present on the gateway, but can be additionally provided in order to connect any other components for the data source system directly to the gateway. For completely new data source systems, the gateway can also be used as a PLC from the outset, so that an initial connection of the data source system to the IT system can be provided.

Furthermore, trust zone support with a security enclave processor SEP is known for a system on chip SOC from U.S. Pat. No. 8,775,757 B2. The system-on-chip SOC implements a security enclave processor SEP. The SEP can contain a processor and one or more security peripherals. The SEP can be separated from the rest of the System on Chip SOC (e.g. one or more central processing units (CPUs) in the SOC or application processors (APs) in the SOC). Access to the security enclave processor SEP can be strictly controlled by hardware. For example, a mechanism is described in which the central processing units CPUs or the application processors (APs) can only access one mailbox in the security enclave processor SEP. The CPU/AP can write a message to the mailbox, which the security enclave processor SEP can read and respond to. The SEP may, in some embodiments, include one or more of the following components: secure key management using wrapping keys, SEP control of boot and/or power management, and separate trust zones in memory.

In further development of this, U.S. Pat. No. 9,747,435 B2 contains a variety of different embodiments for authentication and control of encryption keys known. Generally speaking, a device may include a security circuit, a processor, and an interface controller. The security circuit may be configured to generate a keyword. The processor may be configured to determine one or more policies to apply to the use of the keyword and to generate a policy value. The policy value may contain one or more data bits that specify the particular one or more policies. The interface controller can be configured to generate a message containing the keyword and the policy value. The interface controller can also be configured to: Send the message. In another embodiment, the one or more policies may include an indication of one or more functional units of a plurality of functional units that are permitted to use the keyword. In another embodiment, the one or more policies may include an allowable size for the keyword. In another embodiment, the one or more policies may include an indication that the keyword may be used to encrypt data and an indication that the keyword may be used to decrypt data. In another embodiment, the one or more policies include an indication of a length of time for which the keyword may be used. In one embodiment, the security circuit may be further configured to encrypt the keyword. In another embodiment, the one or more policies may include an indication of one or more additional operations required to be performed on the message to decrypt the keyword.

Modern processor architectures now feature a Secure Enclave that performs security-relevant tasks depending on the product life cycle. Examples of product life cycles are:

| | |
|---|---|
| CM | Chip manufacturing |
| DM | Device manufacturing |
| SE | Security enabled |

During chip manufacturing, it must be possible to test the chip extensively. When the chip leaves the factory, the life cycle is switched “onward” and the interfaces for testing the chip's interior are switched off. When the finished device is installed on-site in a facility, the interfaces necessary for developing the device software are switched off. The software running on the automation device enables additional safety functions to be used in the end application, such as: E.g. secure booting, key management, certificate handling, etc.

Real-time Ethernet, as applied in automation, differs from conventional Ethernet in other industries. For this reason, new concepts must be developed that are not found in classic processor architectures.

Real-time Ethernet in automation technology refers to cyclic data communication between devices. In the future, for devices with transmission rates of 1 Gbps, cycle times will be in the microsecond range. The data is no longer transmitted in plain text, but encrypted.

In this context, cryptography acceleration is important. An edge network can be implemented as any type of network that provides edge computing and/or storage resources located near radio access network or access points. RAN-capable endpoint devices (e.g. mobile computing devices, Internet of Things (IoT) devices, smart devices, etc.). From DE102019130686 A1 a method and a device for providing dynamic selection of edge and local accelerator resources is known, wherein the device comprises circuitry for identifying a function of an application to be accelerated, determining one or more properties of the accelerator resource available at the edge of a network on which the device is located and determining one or more properties of an accelerator resource available in the device. The so-called Edge Devices, in some ways comparable to industrial PCs, extend the functionality to include local accelerators for various tasks such as artificial intelligence, cryptography, (FPGA) etc. Expansion via I/O cards is carried out, for example, via PCIe (Peripheral Component Interconnect Express, usually abbreviated PCIe, is a bus standard for connecting peripheral devices to the chipset of a processor) based expansion card slots. The accelerator device is therefore a type of device extension, similar to how desktop PCs are expanded using slots in the motherboard, for example, has a graphics card or network card plugged in. Windows as the operating system was able to recognize the card, install the driver and make it usable for the application.

Furthermore, a method and a system for key management for secure data transmission are known from DE60314060T2. The secure data transmission system comprises:
a secure channel established via at least one data channel,
a host processor connected to a network to communicate with user applications running on other processors connected to the network,
a main security module connected to the host processor for sending encrypted private keys of an asymmetric private and public key encryption scheme, wherein the private keys have been encrypted using at least one key encryption key, wherein the main security module is further configured to send the encrypted private keys over the data channel and to send the key encryption key over the secure channel, and wherein the main security module comprises a security module configured to control key generation operations and an associated data store.

In particular, the secure data transmission system according to DE60314060T2 is characterized by:
at least one satellite module connected to the host processor for receiving the at least one key encryption key after transmission over the secure channel, for receiving the encrypted private keys after transmission over the data channel, for decrypting the private keys under using the received key encryption key and encrypting or decrypting data using the decrypted private keys, the satellite security module comprising a cryptography accelerator having a key manager, initial parsing units (IPUs), cipher engines, and a non-volatile data memory, EEPROM. Furthermore, the secure data transmission system according to DE60314060T2 is characterized in that the secure channel is established by the host processor and is designed to be used to initialize and control the at least one satellite security module and to facilitate the secure transmission of the key encryption key and management information. The cryptography accelerator of the secure data transmission system according to DE60314060T2 comprises one or more initial parsing units (IPU-Initial Parsing Unit), cipher machines and a key manager. The IPUs parse (analyze) security association data from the encrypted/unencrypted packets to decrypt the encrypted security associations. The encryption engines are processors that decrypt the encrypted packets and/or encrypt the unencrypted packets. In this embodiment, the cipher engines are specific processors that use the decrypted security associations from the Initial Parsing Unit IPUs to encrypt or decrypt packets. The key manager manages the key encryption keys (KEKs) used to decrypt the security associations. The cryptography accelerator can provide on-chip memory for the cache, one for each MCR type (e.g. 96 bytes for MCR1 and 648 bytes for MCR2, enough for the AES 256-bit key IPsec context or the RSA 2048-bit private key context). The cryptography accelerator may include additional instruction code for loading and decrypting an instruction context. The cache and KEK to be used would be determined by the MCR through which the instruction was issued. A cached instruction context would be invoked using a package descriptor with a null instruction context pointer.

Furthermore, a device and a method for handling key encryption are known from U.S. Pat. No. 11,070,375B2. The apparatus includes an encryption key generator for generating a media encryption key for encrypting data in a number of storage components, the encryption key generator being configured to wrap the media encryption key to generate an encrypted media encryption key. The encrypted media encryption key is stored in non-volatile memory. The device includes firmware with instructions for transitioning the device into and out of a secure state using the encrypted media encryption key. The solution known from U.S. Pat. No. 11,070,375B2 describes, in the broadest sense, a type of inline encryption for storage. It involves storing data or program code in encrypted form on the storage medium, i.e. when writing to the memory the data is encrypted and when reading from the memory the data is decrypted. It is primarily about the application of memory chips. The memory chips are e.g. connected to a communications processor. This is intended to prevent third parties from reading the memory contents and thus from revealing secrets.

Finally, a cost-effective cryptography accelerator is known from DE102017215331A1. The system comprises:
a central processing unit CPU;
a memory storing instructions which, when executed by the CPU, cause the CPU to perform operations comprising: obtaining cryptographic data, the cryptographic data identifying a specific cryptographic process to be performed on the cryptographic data;
performing a first cryptographic operation on the cryptographic data according to the cryptographic process;
sending the cryptographic data to a hardware accelerator; and receiving, from the hardware accelerator, cryptographic data generated by the hardware accelerator using a second cryptographic operation according to the cryptographic process which is different from the first cryptographic operation.

The cryptography accelerator comprises:
an interface configured to receive cryptographic data, wherein the cryptographic data identifies a specific cryptographic process to be performed on the cryptographic data;
a transformation logic configured to perform a cryptographic operation on the cryptographic data according to the cryptographic process, wherein the transformation logic comprises logic for performing cryptographic operations for a plurality of different cryptographic processes; and
a state register configured to store a result of the cryptographic operation.

Secure communication between end devices in automation technology will become increasingly separate from other industries in the future. The Secure Enclave forms the basis for establishing secure communication. In order to realize an intelligent device with a flexible communication structure for real-time capable network applications with high data security, in particular automation devices with transmission rates in the range of 10 Mbps to 1 Gbps, a further development of the solution concepts known from the state of the art is required.

In order to design an automation device with a module for network analysis and a module for cloud connection in such a way that a dedicated gateway can be dispensed with, the applicant's DE102018008674A1 describes the automation device being designed in such a way that an analysis and cloud unit is integrated as an independent module in an AS IC of the automation device and/or that an Ethernet network controller with an interface for lossless reading of all received data of the network on the device-internal side of Ethernet transmitters of all existing Ethernet ports is connected to the analysis and cloud unit. Alternatively, an analysis and cloud unit is integrated as a standalone module in the automation device and/or an Ethernet network controller is designed with an interface in the form of a UART, SPI, SDIO, MAC, PCIe, dual-port memory, FIFO or similar for exchanging an Ethernet frame with the automation device and/or the internal Ethernet switch of the network controller.

In order to design a device with a flexible communication and control structure and a method for this in such a way that parts of the device can be exchanged, the applicant's DE102006019451A1 discloses a device with a flexible communication and control structure which, for coupling to other devices or a higher-level control device of an automation system via a serial data bus, has:
at least two or more communication interfaces and
at least one programmable logic controller,
   so that the programmable logic controller is designed as an exchangeable unit and the data is transmitted between the communication interfaces in a completely transparent manner and/or further processed via the internal programmable logic controller.

In the method described in DE102006019451A1 of the applicant for configuring a device with two or more communication interfaces and a programmable logic controller,
the exchangeable communication interface is extended by a PLC function for coupling devices of an automation system that communicate with each other via a serial data bus and
this is integrated into the communication path and works completely transparently, both for the device and for a higher-level control device.

Furthermore, EP0982641B1 discloses a bus connection comprising a memory area combined in one module, a communication module and a functional unit with its own program memory space, both of which access the same memory area, wherein blocks of variable size can be formed in the memory area. As the size of the first block increases, the size of the second block decreases and vice versa, whereby communication buffers can be set up in the resizable second block. In detail, the first block is characterized by a switching to the program memory space of the functional unit can be displayed. A physics unit with an asynchronous interface and a synchronous interface is provided for connection to the bus physics.

In order to specify a communication module for a modularly constructed automation system, which relieves the central control unit of the automation system and is particularly suitable for transferring and programming a user program directly from the central unit connected to the communication module into the communication module, the communication module known from DE102009008957A1 comprises a processing unit, preferably designed as a microprocessor, a zero-voltage-safe memory unit interacting therewith for storing a user program and at least two mutually independent, configurable, galvanically isolated serial interfaces. The serial interfaces can be configured using the user programs stored in the memory unit and are designed to take over functions of the interfaces of a central control unit connected to the communication module if these are not sufficient.

Finally, DE102004035843A1 discloses a network processor with a plurality of programmable processor elements, in which:
each processor element of the plurality of processor elements is configured to provide basic communication network protocol functions;
a first part of the plurality of processor elements is configured as a communication network-processor elements; and
a second part of the plurality of processor elements is configured as interface processor elements configured to provide an output communication interface and/or an input communication interface for the network processor according to a communication protocol.

Object of the invention is, based on the solutions known from EP 1 894 113 B1 and EP 2 HO 754 B1 of the applicant, to further develop a device and a method that supports all market-relevant communication protocols in automation technology and enables preprocessing, securing and forwarding of high-priority real-time data in the range of up to 1 Gbps.

This object is achieved, according to claim 1, by a device with flexible communications structure for real-time capable network applications with high data security, that comprises a communications processor which has:
at least one freely programmable communications controller, at least one freely programmable data controller and at least one interactive dual-port RAM memory, wherein the communications processor cooperates with a higher-level control device via a host interface, whereby the higher-level control device is interchangeable,
at least one flexible communication structure integrated in the communications controller, consisting of processor cores programmable as a function of application,
at least one flexible data processing structure integrated in the data controller and having a cryptography accelerator
   and an exchangeable physical interface arranged in the device and connected to the communications controller arranged in the communications processor via signal lines for transmitting an identification code, control data, receive data and transmit data in such a way that processing, filtering and distribution of data streams is implemented with transmission rates in the range from 10 Mbps to 1 Gbps.

Furthermore, this object is achieved, according to claim 7, by a method for configuring a device with a flexible communication structure for real-time network applications with high data security, which has a communication controller, data controller, dual-port RAM memory, Secure Enclave and host interface arranged in a communication processor, in which:
the communication controller and the data controller are freely programmable,
communication controller and data controller cooperate with a higher-level control device via the host interface, making the higher-level control device interchangeable,
for processing, filtering and distributing data streams with transmission rates in the range of 10 Mbps to 1 Gbps, at least one flexible communication structure integrated in the communication controller, consisting of application-dependent programmable processor cores, is provided,
for the pre-processing, securing and forwarding of high-priority real-time data, at least one flexible data processing structure with a cryptography accelerator, integrated in the data controller and consisting of application-dependent programmable processor cores, is provided,
a replaceable physical interface connected to the communication controller is provided in the device and
the Secure Enclave takes on security-relevant tasks depending on the respective product life cycle and makes additional security functions available for the end application, including secure booting, key management, and certificate handling.

The device according to the invention, in particular an automation device, supports all market-relevant communication protocols of automation technology in a surprisingly simple manner due to the multi-protocol capability of the system and distribution of the workload.

In a further development of the invention, according to claim 2, the data controller comprises:
an application-specific processor core for dedicated processing of high-priority real-time data,
a tightly coupled memory with low latency divided into program memory and data memory,
the cryptography accelerator for hash functions, authentication and encryption and decryption of data and
a direct memory access controller for interactive data transfer to relieve the processor core.

This development of the invention has the advantage that performance optimization results from the size and speed, optimized for the respective application. By enabling single-cycle access at best, latency is kept low, the system response becomes deterministic and the real-time capability of the overall system is improved.

In a preferred embodiment of the invention, according to claim 3, the communications processor has a secure enclave, also called a Secure Enclave, with a Secure Enclave processor and a secure non-volatile memory connected to it via a bus, wherein the Secure Enclave takes over security-relevant tasks depending on a respective product life cycle and makes further security functions usable for the end application, including secure booting, key management, certificate handling.

This embodiment of the invention has the advantage that only the Secure Enclave can access the secure non-volatile memory via the bus. All keys used to encrypt user data originate from entropy stored in the Secure Enclave's non-volatile memory. The Secure Enclave lays the basis for secure communication by managing secret keys. Using these keys and special certificates, a session key is negotiated between devices, on the basis of which the cyclic data is encrypted and decrypted. Conventionally, the session key is valid as long as the connection is active. In automation, in the cyclical context, the connection is maintained as long as the system is running. Therefore, according to the invention, it is possible to renew the negotiated session keys during an active connection.

Further advantages and details can be found in the following description of preferred embodiments of the invention with reference to the drawings. The drawing shows:

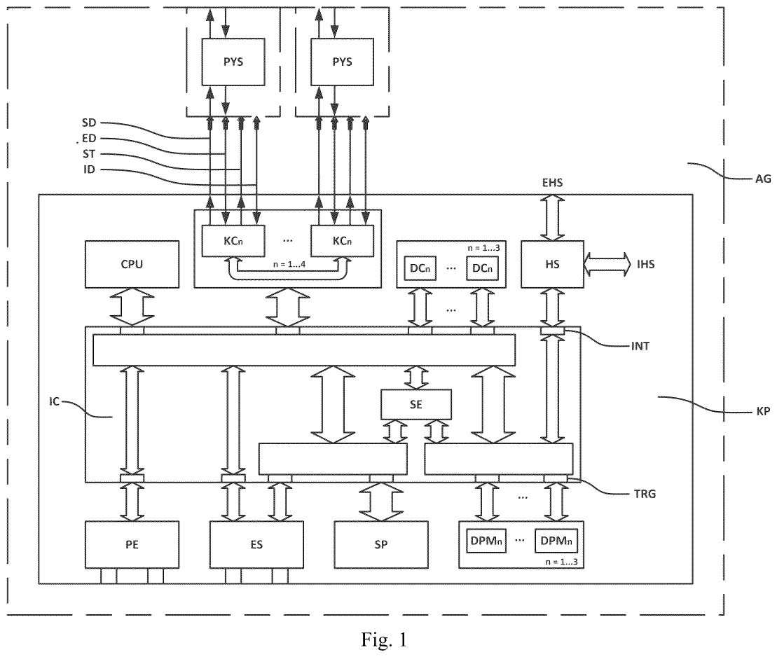

FIG. 1 shows the block diagram of a communication processor with a freely programmable communication controller based on EP1894113B1 and EP2110754 B of the applicants,

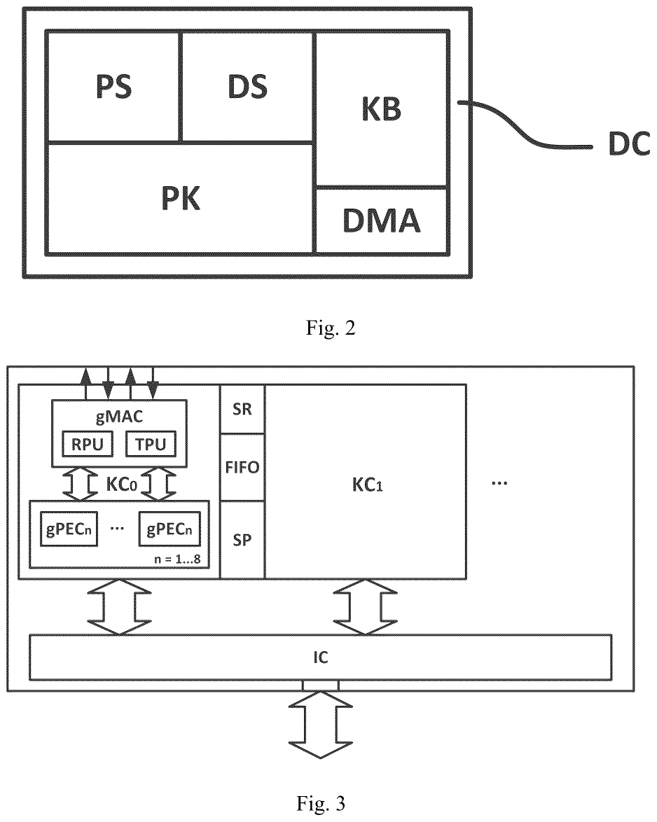

FIG. 2 shows the block diagram of the data controller according to the invention and

FIG. 3 shows the data flow in the device according to the invention with flexible communication structure according to FIG. 1 in detail.

The solution according to the invention of the device with a flexible communication structure, in particular an automation device, shown in FIG. 1 is a further development of the methods and devices for data communication described in EP1894113B1 and EP 2110754B1 of the applicants, for coupling bus participants of an open automation system with distributed control that communicate with each other via a serial data bus. The same reference numerals are used here, so that—by reference to them—the detailed description of the components and their connection to one another can be declared to be part of the description of the further development according to the invention in this patent application.

An intelligent system is a machine with an embedded, internet-connected computer that is capable of collecting and analyzing data and communicating with other systems. The next evolutionary stage is the connection of automation devices to a so-called higher-level cloud. Diagnostic data that the device records about itself or its environment can be used for topics such as predictive maintenance, etc. A representation of the device as a digital twin in the cloud makes it possible, for example, to optimize processes in production plants, etc. The cloud can be on-premise or remote. Plant operators can also access a cloud on-site at the plant without an internet connection. The automation device AG of the present invention is what is nowadays referred to in technical terms as an intelligent device or device referred to as a smart device. The terminology “freely programmable” used in the applicants' EP1894113B1 and EP2110754B1 is intended to distinguish it from devices with a fixed scope of programming by a function or a script make possible. Using a programming language, application-specific tasks and functions can be freely implemented.

For example, there are Ethernet MACs (the abbreviation MAC stands for Media Access Controller and refers to the unique identification and access control of electronic media within a network (Ethernet, Token Ring, Bluetooth or WLAN). The MAC address refers to the specific physical address for the network adapter with a fixed range of functions, which is colloquially programmed via register. In the end, it is primarily a matter of configuration. This does not allow for multi-protocol support. In the solution according to the invention, MACs (Media Access Controllers) are programmable in the communication controller KC to support for example different real-time Ethernet protocols by installing different software.

The block diagram shown in FIG. 1 shows a device, hereinafter referred to as automation device AG, with a flexible communication structure for real-time capable network applications with high data security. The automation device AG contains a communication processor KP, which has:
at least one freely programmable communications controller KC, at least one freely programmable data controller DC and at least one interactive dual-port RAM memory DPM, wherein the communication processor KP cooperates with a higher-level control device via a host interface HS, whereby the higher-level control device is interchangeable,
at least one flexible communication structure integrated in the communication controller KC, consisting of application-dependent programmable processor cores PK (RPA, TPA, PEA, see EP 1 894 113 B1 and EP 2 110754 B1 of the applicant) and hereinafter referred to as gMAC: RPU, TPU and
at least one flexible data processing structure with cryptography accelerator KB integrated in the data controller DC.

Furthermore, the automation device AG contains a signal line or signal line groups for transmitting an identification code ID, control data ST, received data ED and transmitted data SD are connected to the exchangeable physical interface PYS arranged in the communication processor KP, so that processing, filtering and distribution of data streams with transmission rates in the range of 10 Mbps to 1 Gbps is realized.

The block diagram shown in FIG. 2 shows a data controller DC, which has:
at least one application-dependent programmable processor core PK for the dedicated processing of high-priority real-time data,
a tightly coupled memory with low latency divided into program memory PS and data memory DS,
the cryptography accelerator KB for hash functions, authentication and encryption and decryption of data and
a direct memory access DMA controller for interactive data transfer to relieve the processor core PK.

Many modern processor architectures are now so-called heterogeneous multi-core processor systems. The CPU (CPU stands for Central Processing Unit) as the main processor is the central unit that interacts with distributed systems (also called subsystems). To distinguish them from the CPU, the processor cores PK of the subsystems are referred to below as application-specific processor cores PK.

In microcomputer technology, the processor core consists primarily of the control unit, the arithmetic unit, and the registers. The arithmetic unit is also called an arithmetic and logical unit (ALU for short).

The application-specific processor cores PK are equipped with tightly coupled memory (English for Tightly-Coupled Memory, hence abbreviated TCM) for the real-time execution of program code.

The technical term used for “tightly coupled” memory is TCM (Tightly Coupled Memory), which is defined by the architecture of the processor core PK used. Ultimately, it's about optimizing performance due to physical limitations resulting from the semiconductor process and the system architecture of the chip. The processor core PK has, among other things, a system interface and a dedicated TCM interface, divided into a data bus and a program bus. Physically, in the layout of the chips, the TMCs are placed near the processor core PK and connected directly. High-speed memory cells are used for this purpose, which usually have higher power dissipation. The balance between size and speed, optimized for the respective application, defines the performance. The design goal is to keep latency as low as possible, ideally enabling single-cycle access. This makes the system response deterministic and improves the real-time capability of the overall system. In hard real time, exceeding a fixed response time is considered a failure by the application-dependent programmable processor cores PK.

Compared to traditional memory accesses in the system, this is referred to as tightly coupled memory with low latency. If one of the data controller DCs accesses the system memory (outside the DC) via the system bus, higher latencies can be expected, which depend on several factors, e.g. the number of bus participants working on the system memory, the respective data traffic on the system bus, internal synchronization levels, etc., i.e. latencies, measured in the number of processor clock cycles, can be in the double-digit range. During this time, the application-dependent programmable PK does nothing other than wait for data access. The DMA (Direct Memory Access) controller is used to relieve the load on the application-dependent programmable processor core (PK). The DMA controller executes memory accesses in the system. The application-dependent programmable processor core PK does not waste clock cycles waiting, but instead executes program instructions.

As part of the further development of the solution according to EP1894113 B1 the applicant has extended the communications controller KC to meet future communication protocol requirements and network transmission requirements, as follows and as shown in detail in FIG. 3:
Each communications controller KC consists of several, in particular ten or more application-dependent programmable PKs with communication ALUs
The parallel processor cores PK, referred to as RPU (Receive Processing Unit) and TPU (Transmit Processing Unit), form the gMAC (gigabit MAC).

The control of the transmission and reception process of associated data packets is carried out by several, in particular two times four gPECs (gigabit Protocol Execution Controllers),

whereby the integrated flexible communication structure is formed by means of the application-dependent programmable PK with communication ALUs and is not fixed.

The number of freely programmable communications controllers KC depends on the expansion level of the device AG for the respective application:
1) End devices for process automation occasionally have only one communication port (i.e. a communications controller KC is in use). This is usually due to a star-shaped network topology.
2) End devices for factory automation have at least two communication ports (i.e. two KC communications controllers are in use). This is usually due to a ring-shaped network topology.
4) Devices for control systems can have up to 4 communication ports (i.e. four KC communications controllers are in use). This is usually independent of the implementation of the respective network topology.

The data controller DC according to the invention with integrated cryptography accelerator KB meets the requirements of devices with transmission rates of 1 Gbps, where the cycle times are in the microsecond range and where the data is transmitted in encrypted form. A distinction is made between cyclic receive data, cyclic transmit data and acyclic data.

The interconnect IC is a key component that connects the various functional blocks. The Interconnect IC manages the data flow between these components and ensures that they work together efficiently and effectively. The IC thus provides an internal communication connection for data and control signals. A distinction is made between initiator INT and target TRG (see FIG. 1). This means that an initiator INT is able to perform write and read access to a target TRG. In FIG. 3 the access path through the IC is shown from top to bottom. The Secure Enclave SE is a special feature, as it is both an initiator INT and a target TRG. During the boot phase, the Secure Enclave SE accesses the storage SP and the external storage via the external storage interface ES, e.g. for Secure Boot, etc. During runtime, the Secure Enclave SE provides special services to the parent system, e.g. for key management, etc.

The dual-port RAM DPM for the host interface HS is a volatile memory with arbitration, triple buffering and handshake mechanisms for synchronization, so that two sides can access memory contents in the dual-port RAM DPM separately and thus exchange cyclic and acyclic data with each other. It thus represents a physical separation between the real-time protocol communication and the higher-level control device of the end application, which is connected to an external host interface EHS and is therefore interchangeable.

The higher-level control device with the corresponding host application can be any device class of factory or process automation, such as e.g. an industrial PC, a machine, a drive, an actuator, an I/O system, a sensor, etc.

In the case of an external host interface EHS, the implementation of the end application takes place on commercially available microprocessors or microcontrollers or on application-specific FPGA or ASIC solutions (FPGA stands for Field Programmable Gate Array and ASIC stands for Application Specific Integrated Circuit). Using the host interface HS, the control device of the end application (also called host system) docks to the communication processor KP.

In the case of an internal host interface IHS, the communication processor KP is extended by a complete application system with main processor and thus becomes a system-on-chip (SOC) that can be used as a single-chip solution for end applications.

Today's cryptography includes four major goals for protecting information: confidentiality/access protection, integrity/change protection, authenticity/protection against counterfeiting, binding nature/non-repudiation. In modern cryptography, three main encryption methods are distinguished:
Symmetric cryptography. In symmetric cryptography, a single key is used to encrypt and decrypt a message.
Asymmetric cryptography.
Hybrid cryptography.

Within the scope of the invention, the following cryptographic algorithms can be used,
Hash/HMAC
   MD5
   SHA1
   SHA2
   SHA-224
   SHA-256
   SHA-384
   SHA-512
AES
   key lengths
   AES-128
   AES-192
   AES-256
   Operating modes
   ECB
   CBC
   CTR
   GCM
ChaCha20
   Without authentication
   Combined with Poly 1305
   Polyl 305 without ChaCha20

When it comes to data encryption, AES (Advanced Encryption Standard) encryption remains undeniably one of the most secure and widely used systems in the world.

Other ciphers include: Salsa20 (also Snuffle 2005) is a stream cipher developed in 2005 by Daniel J. Bernstein and is a family of 256-bit stream ciphers. Salsa20/20 with 20 rounds is planned as standard. XSalsa20 is a variant with an extended nonce (192 bits instead of 64 bits). ChaCha or Snuffle 2008 are variations of Salsa20. ChaCha20-Polyl305 is an Authenticated Encryption Algorithm with Additional Data (AEAD) that combines the ChaCha20 stream cipher with the Polyl 305 message authentication code. Its use in IETF protocols is standardized in RFC 8439. It has fast software performance and is typically faster than AES-GCM without hardware acceleration. The ChaCha20-Polyl305 algorithm, described in RFC 8439, takes a 256-bit key and a 96-bit nonce as input to encrypt a plaintext with a ciphertext extension of 128 bits (the tag size). In the ChaCha20-Polyl305 construction, ChaCha20 is used in counter mode to derive a keystream which is XORed with the plaintext. The ciphertext and associated data are then authenticated using a variant of Polyl305, which first encodes the two strings into one. The XChaCha20-Polyl305 construction is an extended 192-bit nonce variant of the ChaCha20-Polyl305 construction that uses XChaCha20 instead of ChaCha20. When randomly selecting nonces, the XChaCha20-Polyl305 construction provides better security than the original construction.

The data processing structure of the data controller DC depends on the software that the processor core PK executes. The respective software is determined by the data model of the higher-level communication protocol, which can vary depending on the communication standard. This also applies, among other things, to the use of the respective encryption algorithm. For example, communication standard A prescribes ASE as the algorithm and communication standard B prescribes ChaCha as the algorithm. Furthermore, the data controllers DC run task-specific data models that differ from each other. A distinction is made between cyclic receive data, cyclic transmit data and acyclic data. Therefore, in the solution according to the invention, several (at least three) data controllers DC are implemented in the system. A purely hardware-based cryptography accelerator KB would be disadvantageous. This would make it impossible to achieve multi-protocol capability of the system and to distribute the workload. The algorithms are accelerated using a combination of software and hardware. The software in the tightly coupled memory (TCM), which the processor core (PK) executes, ensures that the data in the tightly coupled memory is processed according to the data model using the hardware accelerator.

In summary, the method according to the invention for configuring the device AG with a flexible communication structure for real-time capable network applications with high data security, which comprises the communications controller KC, data controller DC, dual-port RAM memory DPM, secure enclave SE and host interface HS arranged in the communications processor KP, is characterized by:
the communications controller KC and the data controller DC are freely programmable,
communications controller KC and data controller DC work together with a higher-level control device via the host interface HS, which makes the higher-level control device interchangeable,
for processing, filtering and distribution of data streams with transmission rates in the range of 10 Mbps to 1 Gbps, at least one flexible communication structure integrated in the communication controller KC, consisting of application-dependent programmable processor cores PK, is provided,
for the processing, securing and forwarding of high-priority real-time data, at least integrated in the data controller DC one flexible data processing structure with cryptography accelerator KB, consisting of application-dependent programmable processor cores PK, is provided,
an exchangeable physical interface PYS is provided in the device AG connected to the communication controller KC and
the Secure Enclave SE takes on security-relevant tasks depending on the respective product life cycle and makes additional security functions available for the end application, including secure booting, key management and certificate handling.

Preferably, the Secure Enclave SE manages secret keys, which are used to negotiate a session key between the devices using these keys and special certificates, on the basis of which the cyclic data is encrypted and decrypted. The session key is valid as long as the connection is active; in particular, the negotiated session key is renewable during an active connection.

Furthermore, according to the invention, with respect to the cryptographic algorithms determined by the data model of a higher-level communication protocol, the software structure of the cryptography accelerator KB is modified to realize the multi-protocol capability of the device AG and to distribute the workload.

The invention is not limited to the illustrated and described embodiments, but also includes all embodiments having the same effect within the meaning of the invention and is in particular only limited by the patent claims.

### LIST OF REFERENCE SYMBOLS

AG: Automation device
CPU: Central Processing Unit
DC: Data Controller
DPM: Dual-Port RAM
DS: Data storage
DMA: Direct Memory Access Controller
ED: Reception data
EHS: External host system
ES: external storage interface
FIFO: First In First Out data buffer
gMAC: gigabit Media Access Controller
HS: Host interface
ID: Identification code
IC: Interconnect
IHS: Internal host system
INT: Initiator
KB: cryptography accelerator
KC: communications controller
KP: communications processor
PE: Peripherals
PK: Processor core
PS: physical interface
PSP: Program memory
RPU: Receive Processing Unit
SD: Broadcast data
SE: Secure Enclave
SP: Memory
SR: Shared Register
ST: Control data
TPU: Transmit Processing Unit
TRG: Target

1-10. (canceled)

11: A device with a flexible communications structure for real-time capable network applications with high data security, said device comprising:
a communications processor which has:
at least one freely programmable communications controller, at least one freely programmable data controller and at least one interactive dual-port RAM memory, wherein the communications processor interacts with a higher-level control device via a host interface, whereby the higher-level control device is exchangeable;
at least one flexible communication structure integrated in the communications controller, said at least one flexible communication structure comprising application-dependent programmable processor cores; and
at least one flexible data processing structure integrated in the data controller, said at least one flexible data processing structure including a cryptography accelerator; and
an interchangeable physical interface arranged in the device that is connected to the communications processor via signal lines for transmitting an identification code, control data, reception data and broadcast data in such a way that processing, filtering and distribution of data streams is implemented with transmission rates in the range from 10 Mbps to 1 Gbps.

12: The device according to claim 11, wherein the data controller comprises:
at least one application-dependent programmable processor core for the dedicated processing of high-priority real-time data;
a tightly coupled, low-latency memory divided into program memory and data memory;
the cryptography accelerator for hash functions, authentication and encryption and decryption of data; and
a Direct Memory Access controller for interactive data transfer to relieve the processor core.

13: The device according to claim 11, wherein the communication processor has a secure enclave, with a secure enclave processor and a secure non-volatile memory connected to the secure enclave via an internal bus, wherein the secure enclave takes over security-relevant tasks depending on a respective product life cycle and makes further security functions usable for the end application, including secure booting, key management, certificate handling.

14: The device according to claim 12, wherein the communication processor has a secure enclave, with a secure enclave processor and a secure non-volatile memory connected to the secure enclave via an internal bus, wherein the secure enclave takes over security-relevant tasks depending on a respective product life cycle and makes further security functions usable for the end application, including secure booting, key management, certificate handling.

15: The device according to claim 11, wherein in a ring-shaped embodiment of the network topology the device for factory automation has at least two communications controllers and that independently of the network topology the devices have up to four communications controllers.

16: The device according to claim 12, wherein the communications processor has at least three data controllers for distinguishing between cyclic receive data, cyclic transmit data and acyclic data.

17: The device according to claim 11, wherein the communication controller comprises a plurality of application-dependent programmable processor cores with communication ALUs (Arithmetic and Logical Units), wherein parallel processor cores (PK) referred to as an RPU (Receive Processing Unit) and a TPU (Transmit Processing Unit) form a gMAC (gigabit Media Access Controller), wherein control of the transmission and reception process of associated data packets is carried out by several gPECs (gigabit Protocol Execution Controllers), whereby an integrated flexible communication structure is formed by means of the application-dependent programmable processor cores with communication ALUs.

18: The device according to claim 12, wherein the communication controller comprises a plurality of application-dependent programmable processor cores with communication ALUs (Arithmetic and Logical Units), wherein parallel processor cores (PK) referred to as an RPU (Receive Processing Unit) and a TPU (Transmit Processing Unit) form a gMAC (gigabit Media Access Controller), wherein control of the transmission and reception process of associated data packets is carried out by several gPECs (gigabit Protocol Execution Controllers), whereby an integrated flexible communication structure is formed by means of the application-dependent programmable processor cores with communication ALUs.

19: A method for configuring a device with a flexible communications structure for real-time capable network applications with high data security, which device has a communications controller, data controller, dual-port RAM memory, secure enclave and host interface arranged in a communications processor, in which:
the communications controller and the data controller are freely programmable;
communications controller and data controller cooperate with a higher-level control device via the host interface, whereby the higher-level control device is interchangeable;
for processing, filtering and distributing data streams with transmission rates in the range of 10 Mbps to 1 Gbps, at least one flexible communication structure integrated in the communications controller, consisting of application-dependent programmable processor cores, is provided;
for pre-processing, securing and forwarding high-priority real-time data, at least one flexible data processing structure integrated in the data controller with cryptography accelerator, consisting of application-dependent programmable processor cores is provided;
an exchangeable physical interface connected to the communications controller is provided in the device; and
the Secure Enclave takes on security-relevant tasks depending on the respective product life cycle and makes additional security functions available for the end application, including comprehensive secure booting, key management and certificate handling.

20: The method according to claim 19, wherein for cyclic data communication the data controller distinguishes between cyclic receive data, cyclic transmit data and acyclic data.

21: The method according to claim 19, in which the Secure Enclave manages secret keys, using these keys and special certificates a session key is negotiated between devices, on the basis of which the cyclic data is encrypted and decrypted, the session key is valid as long as the connection is active and during an active connection the negotiated session key is renewable.

22: The method according to claim 20, in which the Secure Enclave manages secret keys, using these keys and special certificates a session key is negotiated between devices, on the basis of which the cyclic data is encrypted and decrypted, the session key is valid as long as the connection is active and during an active connection the negotiated session key is renewable.

23: The method according to claim 19, in which the software structure for the application of the cryptography accelerator is changed with respect to the cryptographic algorithms determined by the data model of a higher-level communication protocol in order to realize the multi-protocol capability of the device and to divide the workload.
